(19) United States
(12) Patent Application Publication
(10) Pub. No.: US 2026/0048446 A1
(43) Pub. Date: Feb. 19, 2026

(54) HARD FINISHING MACHINE

(71) Applicant: KAPP NILES GmbH & Co. KG, Coburg (DE)

(72) Inventors: Christopher GOEBEL, Ahorn (DE); Johannes RITZ, Sonnefeld (DE); Jan SENFTLEBEN, Coburg (DE)

(21) Appl. No.: 19/298,316

(22) Filed: Aug. 13, 2025

(30) Foreign Application Priority Data
Aug. 16, 2024 (DE) 10 2024 123 482.2

(51) Int. Cl. B23F 19/02

(52) U.S. Cl. CPC B23F 19/02

(57) ABSTRACT

A hard finishing machine for machining workpieces with at least one gearing, in particular a gear grinding machine, including a spindle rotated by a motor, wherein the spindle has, at a first axial position, a first sensor system for detecting rotation of the spindle at the first axial position, wherein the first sensor system is connected to a control unit for controlling rotation of the spindle. A second sensor system is arranged at a second axial position of the spindle, which is designed to detect rotation of the spindle at the second axial position, wherein the second sensor system is connected to a measuring device, wherein a further sensor system is arranged at the first axial position of the spindle, which is designed to detect rotation of the spindle at the first axial position and is also connected to the measuring device.

### CROSS-REFERENCE TO RELATED APPLICATIONS

The present application claims priority of DE 10 2024 123 482.2, filed Aug. 16, 2024, the priority of this application is hereby claimed, and this application is incorporated herein by reference.

### BACKGROUND OF THE INVENTION

The invention relates to a hard finishing machine for machining workpieces with at least one gearing or with at least one profile, in particular a gear grinding machine, comprising at least one spindle rotated by a motor, wherein the spindle has at a first axial position a first sensor system for detecting the rotation, in particular the rotational angle and/or the rotational speed and/or the rotational acceleration, of the spindle at the first axial position, wherein the first sensor system is connected to a control unit for controlling the rotation of the spindle, wherein at a second axial position of the spindle, which is different from the first axial position, a second sensor system is arranged, which is designed to detect the rotation, in particular the rotational angle and/or the rotational speed and/or the rotational acceleration, of the spindle at the second axial position, wherein the second sensor system is connected to a measuring device, wherein a further sensor system is arranged at the first axial position of the spindle, which is designed to detect the rotation, in particular the rotational angle and/or the rotational speed and/or the rotational acceleration, of the spindle at the first axial position, which is also connected to the measuring device.

A generic hard finishing machine is known from DE 10 2009 059 331 A1. The machine equipment described therein is used to precisely determine the gear positioning. For this purpose, additional sensors record measurement data relating to parameters of the gear teeth of the workpiece to be machined. Similar and other solutions are shown in DE 10 2005 036 332 A1, in DE 10 2021 209 049 A1, in DE 10 2012 022 661 A1 and in DE 10 2020 127 510 A1.

Generally, such hard finishing machines are well known in the art. The rotation of a workpiece spindle takes place in a closed control loop, in particular in conjunction with a tool spindle that is also controlled in a closed control loop, to ensure that there is precise coupling between the rotation of the workpiece and the tool (e.g. grinding worm). This is necessary in order to machine the workpiece's teeth precisely in accordance with the desired specifications.

For good grinding results, it is particularly important to ensure that no impermissibly high vibrations occur in the components involved during machining. Accordingly, an efficient vibration monitoring system must be installed on the machine.

When monitoring machine parameters, and in particular the rotation of a spindle in a hard finishing machine, it is generally possible to use the measuring functions provided by the machine control system. Alternatively, measuring functions provided by a digital-to-analogue converter (DAC) can be used. However, both options have disadvantages, as either the sampling rate of the signals (traces) is too low to perform a detailed vibration analysis, or the accuracy (resolution) of the signals is insufficient to detect low vibration amplitudes with sufficient accuracy.

Direct processing of the encoder's measurement signals, which are used to control the rotation of the spindle, i.e. an additional measurement branch on the reading head for parallel measurement of the raw signals, is not permitted for safety reasons.

Attached acceleration sensors (uniaxial or triaxial), such as those installed near the floating and locating bearings, can detect vibrations, but this measurement technology can only accurately detect translational vibrations, not rotational vibrations.

It is also possible to implement external current measurement; however, the current is influenced by controller settings (including special filters in the control loop).

This means that there is no sufficiently accurate way of completely detecting specific types of vibration occurring at the spindle, especially automatically during the machining process, and of initiating appropriate measures if necessary.

### SUMMARY OF THE INVENTION

The invention is based on the object of further developing a generic hard finishing machine in such a way that it is possible to provide an improved metrological arrangement that enables vibration modes in the machine to be better detected. This should enable measures to be taken in good time to effectively remedy any vibrations that occur. Furthermore, it should be possible to automatically initiate measures to improve the dynamic behaviour of the machine.

The solution to this problem provided by the invention is characterised in that the first sensor system at the first axial position comprises a measuring tape connected to the rotating part of the spindle and a reading head connected to the non-rotating part of the spindle for reading the signals of the measuring tape, wherein the further sensor system at the first axial position of the spindle comprises a further reading head for reading the signals of the measuring tape, wherein the second sensor system at the second axial position comprises a further measuring tape connected to the rotating part of the spindle and a further reading head connected to the non-rotating part of the spindle for reading the signals of the further measuring tape.

Although, as explained, the aforementioned additional sensor system is arranged at the first axial position of the spindle, this also includes a location close to this position.

Accordingly, the rotary encoder (or measuring tape) required for controlling the rotation of the spindle within the closed-loop control concept is used to supply data to the further reading head, which supplies signals to the measuring device.

The measuring device is preferably designed as a unit separate from the control device.

The spindle can be a workpiece spindle or a tool spindle, but it can also be one that causes an axis movement of the machine (i.e. a rotary or linear drive of a machine axis).

It is advantageous to arrange the second rotary encoder (consisting of a measuring tape and a read head) at a position that can measure all relevant rotary vibration modes, or at least those that cannot be measured by the first rotary encoder. The reason for suboptimal detection of a rotary vibration mode may be that the position of the rotary encoder is located at a node of a vibration mode. Such positions can be determined, for example, by means of FEM analysis.

The second sensor system is preferably arranged in the area of a locating bearing of the spindle.

At least one additional sensor for detecting translational accelerations may be arranged on the spindle and connected to the measuring device. In this case, the sensor for detecting translational accelerations is preferably designed to detect acceleration in three axial directions.

The measuring device is preferably designed to evaluate the frequencies and/or the amplitudes and/or the phase positions of the signals received by the second sensor system, by the further sensor system and, if applicable, by the sensor for detecting translational accelerations.

According to the proposed solution, additional sensors are integrated into the workpiece axis and, if necessary, into the tool axis (and, if applicable, into other axes of the machine), which enable more accurate and dynamic measurement of the machine dynamics and, in particular, the rotational speeds (as a vibration-relevant variable).

This opens up previously unavailable possibilities for analysing the machining process in terms of vibration modes, amplitudes and associated noise-critical orders.

Based on an (automated) analysis, measures (automated, semi-automated or simply as a notification to a machine operator) can then be initiated to optimise or correct the machining process as required.

Since direct tapping (as a signal splitter) of the rotary encoder required for controlling the rotation of the spindle is not permitted, the present proposal provides the use of one or more additional measuring tapes and read heads in order to improve the detection of the dynamic behaviour of the spindle during rotation. This additional sensor system is not integrated into the control loop that regulates the rotation of the spindle; instead, the signals are transmitted to a separate measuring device where they are evaluated.

As stated above, the second sensor system should be arranged at a second axial position of the spindle. If tailstocks (e.g. for workpiece axes) or counter bearings (e.g. for tool axes) are used in a specific application, this shall be understood to mean that the tailstock or counter bearing is also to be assigned to the spindle and that the second sensor system (and, if necessary, a third sensor system) can also be placed in these components. This also applies to translational acceleration sensors, if applicable. This may allow the resulting vibration mode to be determined even better and in greater detail in a specific application.

The various features of novelty which characterize the invention are pointed out with particularity in the claims annexed to and forming a part of the disclosure. For a better understanding of the invention, its operating advantages, specific objects attained by its use, reference should be had to the drawings and descriptive matter in which there are illustrated and described preferred embodiments of the invention.

### BRIEF DESCRIPTION OF THE DRAWING

In the drawings:

FIG. 1 schematically shows a workpiece spindle of a gear grinding machine equipped with a sensor system according to the invention; and

FIG. 2 shows a flow chart for automatic optimisation of the grinding process of a gear.

### DETAILED DESCRIPTION OF THE INVENTION

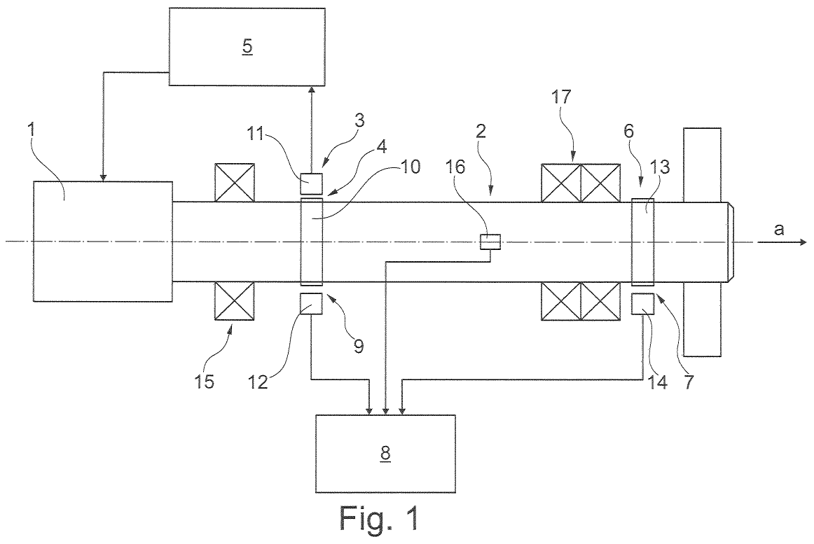

FIG. 1 shows a spindle 2 in the form of a workpiece spindle of a gear grinding machine, which is driven by a motor 1. The spindle 2 is mounted by means of a locating bearing at a locating bearing area 17 and by means of a floating bearing at a floating bearing area 15 and rotates driven by the motor 1 about the axis a. The rotation of the spindle 2 is caused by a closed-loop control unit 5, which controls the motor 1 in such a way that a predetermined rotation of the spindle 2 is performed.

For this purpose, the rotation of the spindle, in particular its angle of rotation, must be known. For this purpose, the spindle 2 has a first sensor system 4 at a first axial position 3, which consists of a measuring tape 10 and a reading head 11; the reading head 11 supplies data to the control unit 5.

In this respect, the design corresponds to the state of the art.

It is essential that a second sensor system 7 is arranged at a second axial position 6 of the spindle 2, which is different from the first axial position 3, and is designed to detect the rotation of the spindle 2 at the second axial position 6. The second sensor system 7 is connected to a measuring device 8. In addition, a further sensor system 9 is arranged at the first axial position 3 of the spindle 2, which is designed to detect the rotation of the spindle 2 at the first axial position 3; this is also connected to the measuring device 8.

A further reading head 12 is provided at the first axial position 3, which also accesses the measuring tape 10 and detects signals from it; these are then forwarded by the further reading head 12 to the measuring device 8.

The second sensor system 7 at the second axial position 6 also consists of a further measuring tape 13 connected to the spindle and a further reading head 14 which transmits its signals to the measuring device 8.

A sensor 16 for detecting translational accelerations is also arranged on spindle 2, which transmits its signals (if necessary via wireless communication) to the measuring device 8 in the same way.

A preferred solution therefore includes an additional reading head on the measuring tape; the reading head and measuring tape form the rotary encoder, which is used for control. In addition, another measuring tape is installed at a different position (for example, near the locating bearing of the spindle).

Furthermore, translational acceleration sensors (ideally triaxial sensors, which can measure acceleration in three axes) are installed at various bearing points.

This makes it possible to use the measuring device 8 to analyse the machining process much more accurately and to evaluate it with regard to any vibrations that occur. The vibration modes, including frequencies, amplitudes and phase positions, are preferably captured so that, based on this, remedial measures can be initiated if necessary to ensure a more stable machining process.

The additional use of further measurement technology, particularly in the form of rotary acceleration sensors, may provide more accurate results.

It is also possible to use an appropriate algorithm to display the measures directly on the machine or even execute them directly. Alternatively, a message can be sent to the machine operator.

In this context, faster and more detailed error analysis for special cases that occur and would otherwise not be detectable is advantageous.

With the proposed solution, torsional and bending vibrations can be easily detected and differentiated, which is not the case with the previously known solutions.

By using the additional read head or an additional measuring tape, rotary vibrations (i.e. torsional vibrations) can be recorded with high precision and dynamically in addition to translational vibrations via the acceleration sensors. Various acceleration sensors are sometimes already installed in generic hard finishing machines, which can be used additionally for signal analysis.

The measured values are evaluated in the measuring device 8. The measuring device can be part of an industrial PC in which the measured values are recorded synchronously.

The analysis is typically performed using frequency analysis. This involves analysing the frequencies, amplitudes and phase positions of the signals.

Another piece of information that is ideally available for analysis is the processing parameters of the process.

The analyses can be carried out on the basis of an operational vibration mode analysis (in conjunction with a FEM simulation or an experimental modal analysis). This determines whether a vibration mode is characteristic of the process (e.g. due to the tool engaging with the workpiece) or whether it is disruptive or problematic for the process.

A “fault catalogue” based on experience can serve as the basis for possible measures that may be initiated independently and automatically by the system. Using an appropriate algorithm, which can also take probability considerations into account, a corrective measure can then be carried out or suggested automatically, semi-automatically or by means of a message to the machine operator.

Another option for analysis and initiating measures is the use of algorithms from the fields of artificial intelligence (AI) and machine learning (ML). Both the classic and ML approaches allow feedback on the success of the measure by analysing the subsequent processing steps, enabling the measures to be optimised independently.

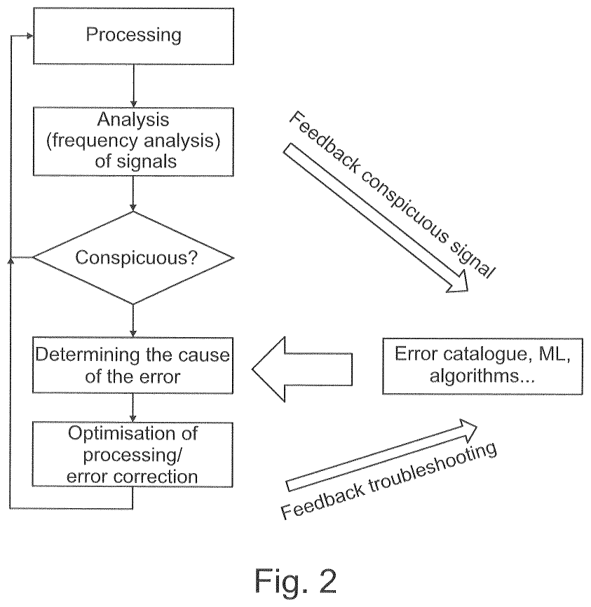

Reference is made to FIG. 2 for the latter procedure. This figure shows a flow chart illustrating the procedure described above as an example.

First, a workpiece is processed and then the measured values recorded in the measuring device 8 are analysed (frequency analysis of the signals). In the next step, the recorded signals are checked to see whether they are abnormal or not. For this purpose, measured values or quantities derived from them (such as the amplitudes of certain harmonics of the recorded vibrations) can be compared with specified values.

If the signal is conspicuous, it can be compared with an error catalogue so that the cause of the error can be determined. In this way, there is feedback from an unusual signal to information obtained from the error catalogue. The term “error catalogue” is derived from known error patterns in processing and the associated recorded signals. Ideally, signal curves from good and bad conditions are available for each error pattern and appropriate corrective measures are stored.

Optimised parameters can then be defined to improve processing or eliminate the identified error. The findings can then be fed back into the error catalogue.

The insights gained from the measurement concept described above can be incorporated into an optimised evaluation algorithm, particularly in the error catalogue mentioned above. AI systems, especially machine learning, are an effective tool for this purpose. This also allows automated error correction to be installed.

This results in a concept that can be processed automatically and constantly monitors the processing results.

While specific embodiments of the invention have been shown and described in detail to illustrate the inventive principles, it will be understood that the invention may be embodied otherwise without departing from such principles.

We claim:

1. Hard finishing machine for machining workpieces with at least one gearing or with at least one profile, in particular a gear grinding machine, comprising at least one spindle rotated by a motor, wherein the spindle has at a first axial position a first sensor system for detecting the rotation, in particular the rotational angle and/or the rotational speed and/or the rotational acceleration, of the spindle at the first axial position, wherein the first sensor system is connected to a control unit for controlling the rotation of the spindle, wherein at a second axial position of the spindle, which is different from the first axial position, a second sensor system is arranged, which is designed to detect the rotation, in particular the rotational angle and/or the rotational speed and/or the rotational acceleration, of the spindle at the second axial position, wherein the second sensor system is connected to a measuring device,
wherein a further sensor system is arranged at the first axial position of the spindle, which is designed to detect the rotation, in particular the rotational angle and/or the rotational speed and/or the rotational acceleration, of the spindle at the first axial position, which is also connected to the measuring device,
wherein the first sensor system at the first axial position comprises a measuring tape connected to the rotating part of the spindle and a reading head connected to the non-rotating part of the spindle for reading the signals of the measuring tape, wherein the further sensor system at the first axial position of the spindle comprises a further reading head for reading the signals of the measuring tape, wherein the second sensor system at the second axial position comprises a further measuring tape connected to the rotating part of the spindle and a further reading head connected to the non-rotating part of the spindle for reading the signals of the further measuring tape.

2. Hard finishing machine according to claim 1, wherein the measuring device is designed as a unit separate from the control unit.

3. Hard finishing machine according to claim 1, wherein the spindle is a workpiece spindle or a tool spindle.

4. Hard finishing machine according to claim 1, wherein the spindle is one that causes an axial movement.

5. Hard finishing machine according to claim 1, wherein the second sensor system is arranged in the area of a locating bearing of the spindle.

6. Hard finishing machine according to claim 1, wherein at least one further sensor for detecting translational accelerations is arranged on the spindle and is connected to the measuring device.

7. Hard finishing machine according to claim 6, wherein the sensor for detecting translational accelerations is designed to detect acceleration in three axial directions.

8. Hard finishing machine according to claim 1, wherein the measuring device is designed to evaluate the frequencies and/or the amplitudes and/or the phase positions of the signals received by the second sensor system, by the further sensor system and, if applicable, by the sensor for detecting translational accelerations.
